(19) United States
(12) Patent Application Publication
(10) Pub. No.: US 2011/0221111 A1
(43) Pub. Date: Sep. 15, 2011

(54) Multiple Cutting Board Apparatus

(76) Inventor: R. Todd Stigall, Cypress, TX (US)

(21) Appl. No.: 12/721,971

(22) Filed: Mar. 11, 2010

(51) Int. Cl. A47J 47/00

(52) U.S. Cl. 269/9; 269/289 R

(57) ABSTRACT

A cutting board assembly including a primary cutting board and a secondary cutting board. The secondary cutting board is housed within a void space of the primary cutting board, providing the ability to use multiple cutting surfaces within one conveniently arranged cutting board.

### FIELD

The present invention is generally related to a cutting board. More specifically, the present invention is related to a cutting board for use in multiple cutting purposes.

### BACKGROUND

Preparation of food items often involves a preparation step of cutting, slicing, chopping, dicing, etc. of the food items by using a knife or other sharp object. Typically, such cutting steps are performed on a flat surface such as a kitchen counter top or a movable flat surface such as a cutting board. The use of cutting boards allows for the cutting, slicing, dicing, chopping, etc. to be performed in many areas of the kitchen while protecting permanent surfaces, such as counter tops, from damage that may result from using cutting tools.

Cutting boards, however, can pose a sanitation risk. Food preparation may involve raw meats, which can contaminate the cutting board. In many instances a cutting board is used in the preparation of multiple ingredients. The act of cutting an ingredient such as meat on a cutting board can contaminate the cutting board, which can lead to cross contamination if the cutting board is subsequently used as a cutting surface for other ingredients, such as tomatoes.

To combat contamination, the cutting board can be washed prior to the preparation of each type of food. However, such washing time can cause delays in the food preparation. To overcome the need to constantly wash the cutting board, multiple cutting boards may be used. However, there may not be enough room in a kitchen to use multiple cutting boards when preparing food. Multiple cutting boards may also take up extra space in kitchen storage areas, counter tops, cabinets, etc.

It would be desirable to have a multiple cutting surfaces that are conveniently arranged in a manner that is easy to use and easy store, without occupying additional storage space in the kitchen.

### SUMMARY

The present invention relates to a cutting board assembly having a primary cutting surface and a secondary cutting surface that is housed within the primary cutting board. The primary cutting surface may include a conventional cutting board having a receptacle capable of housing the secondary cutting board. The receptacle may be formed from the primary cutting board itself or attached to the primary cutting board. The secondary cutting board may be completely removable from the primary cutting board.

The present invention relates to a cutting board assembly having a primary cutting board and a plurality of cutting boards situated within the primary cutting board. The primary cutting surface may include a conventional cutting board having a receptacle capable of housing the plurality of cutting boards. The receptacle may be formed from the primary cutting board itself or attached to the primary cutting board. The plurality of cutting boards may be completely removable from the primary cutting board.

### BRIEF DESCRIPTION OF DRAWINGS

FIG. 1 is a top view of a cutting board assembly, showing an extended secondary cutting board.

FIG. 2 is a top view of the cutting board assembly of FIG. 1, showing the secondary cutting board removed from the primary cutting board.

FIG. 3 is an end view of an embodiment of a cutting board assembly.

FIG. 4 is a perspective view of the underneath of the cutting board assembly of FIG. 3.

FIG. 5 is an end view of an embodiment of a cutting board assembly.

FIG. 6 is a perspective view of the underneath of the cutting board assembly of FIG. 5.

FIG. 7 is a top view of a secondary cutting board.

FIG. 8 a top view of an embodiment of the cutting board assembly.

FIG. 9 is an end view of an embodiment of the cutting board assembly.

### DETAILED DESCRIPTION

The present invention provides the ability to use multiple cutting surfaces that are conveniently arranged within one cutting surface. The invention results in an arrangement of cutting surfaces that are easy to use and easy store, without occupying additional storage space.

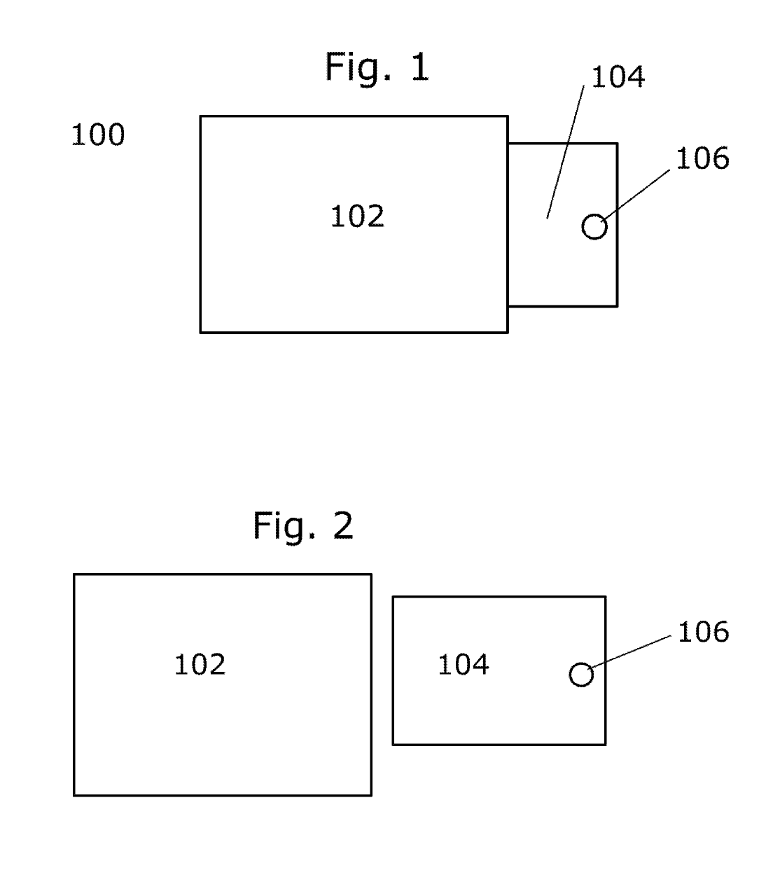

Referring now to the drawings and in particular to FIG. 1, there is shown a cutting board assembly according to an embodiment of the invention indicated generally as 100 having a primary cutting board 102 and a secondary cutting board 104. The secondary cutting board may include a handle 106 to aid in removing the secondary cutting board from the primary cutting board. The handle can be a cut out or partial recess of the secondary cutting board 104. In an embodiment the secondary cutting board is removable from the primary cutting board. FIG. 2 shows the secondary cutting board 104 removed from the primary cutting board 102. In such an embodiment the secondary cutting board is not attached to the primary cutting board.

In an optional embodiment, the secondary cutting board is attached to the primary cutting board such that the secondary cutting board is allowed to slide out from the primary cutting board, in a manner similar to a drawer.

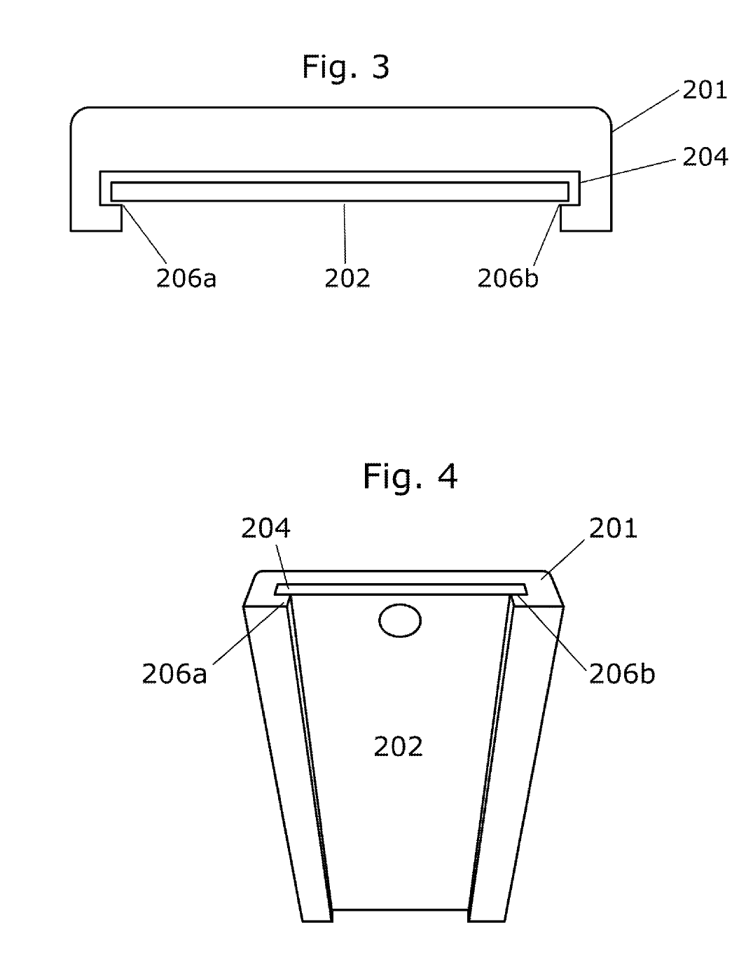

In an embodiment the primary cutting board is adapted to house a secondary cutting board. More specifically, FIG. 3 shows a primary cutting board 201 that is adapted to house a secondary cutting board 202 by the means of a void space 204 that is open as depicted in FIG. 3 and FIG. 4. The void space is of sufficient size to completely house the secondary cutting board. The secondary cutting board is supported in the void space by support members 206a,b. FIG. 4 is a perspective view showing the underside of the present embodiment, wherein a primary cutting board 201 is adapted to house a secondary cutting board 202 by the means of a void space 204 and the secondary cutting board is supported in the void space by support members 206a,b that may extend along the length of the primary cutting board 201, resulting in the underside of the secondary cutting board to be unconcealed when within the primary cutting board.

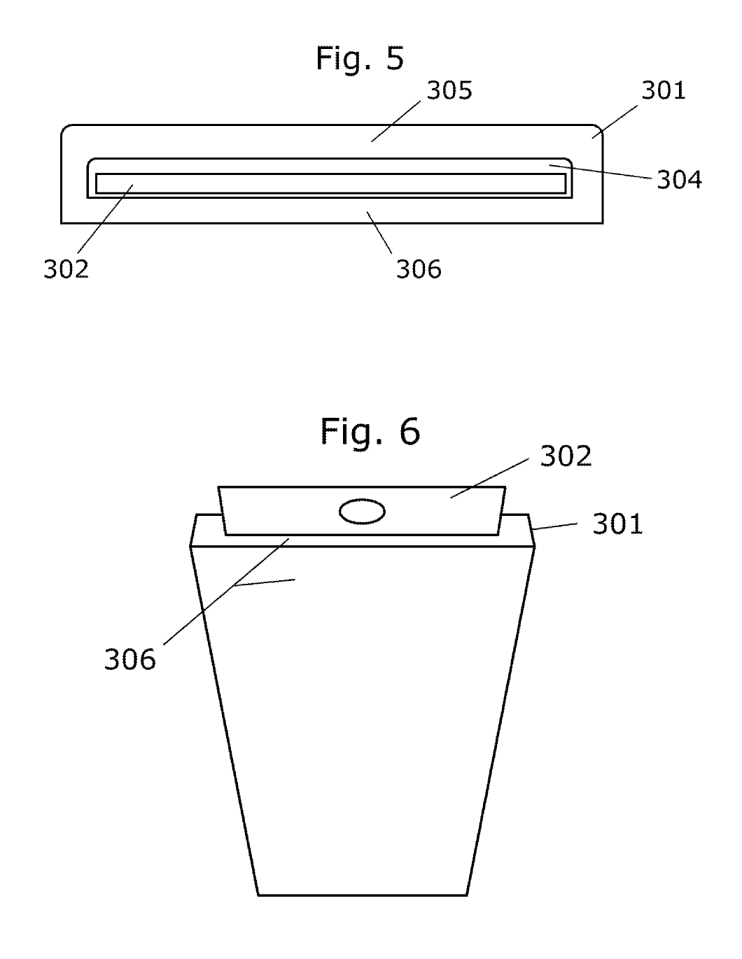

In an embodiment depicted in FIG. 5, a primary cutting board 301 is adapted to house a secondary cutting board 302 by the means of a void space 304 that is closed as depicted in FIG. 5 and FIG. 6. In an aspect the primary cutting board has been hollowed out to create a cavernous space that forms the void space 304, a top section 305, and a bottom section 306. The void space is of sufficient size to completely house the secondary cutting board. The secondary cutting board is supported in the void space by the bottom section 306. FIG. 4 is a perspective view showing the underside of the present embodiment, wherein a primary cutting board 301 is adapted to house a secondary cutting board 302 such that the secondary cutting board is supported by the bottom section 306, which extends along the length of the primary cutting board, resulting in the underside of the secondary cutting board to be concealed when within the primary cutting board.

The primary cutting board may be constructed in order to adapt a second cutting board by any appropriate method. In an aspect the primary cutting board is adapted by shaping a void space by means of a cutting, drilling, molding, forming, etc. The cutting can be accomplished through the use of a drill, saw, jigsaw, or any other cutting tool or combination thereof. In an aspect the primary cutting board is molded to from the shape having a void space. In an additional aspect, the primary cutting board can be constructed by attaching two preformed halves representing a top piece and a bottom piece and when attached, the halves form a primary cutting board containing a void space.

In an embodiment, the primary cutting board is adapted to contain a plurality of secondary cutting boards. The plurality of secondary cutting boards may be stacked on top of each other within the primary cutting board. In an alternate embodiment, the plurality of secondary cutting boards may be individually separated within the primary cutting board. In an aspect, the primary cutting board may contain from 2 to up to 10 secondary cutting boards. In another aspect the primary cutting board may contain from 3 to 5 secondary cutting boards. In an embodiment the secondary cutting boards may all be constructed from the same material. In another embodiment the secondary cutting boards may each be constructed from different materials.

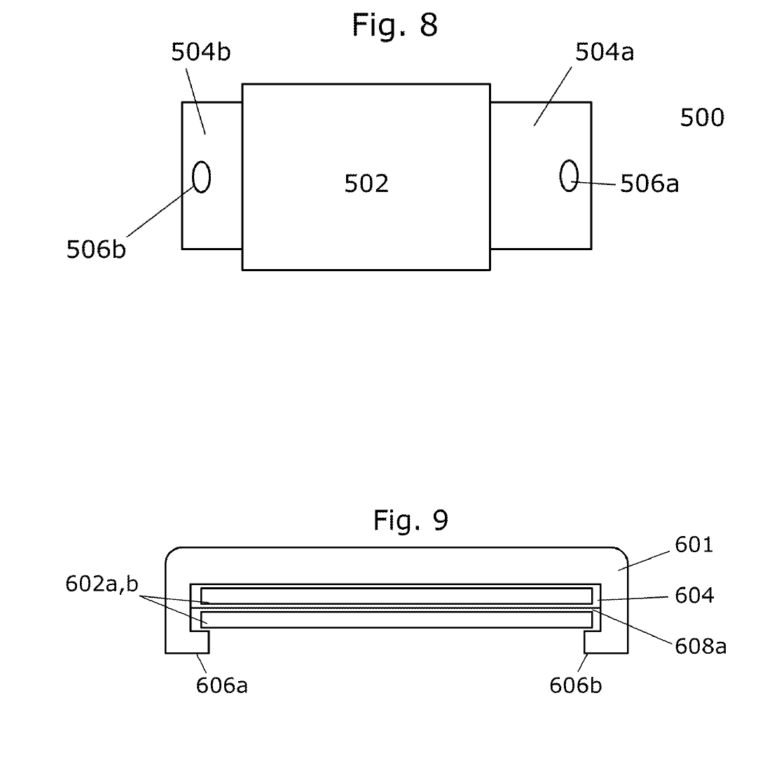

Referring again to the drawings and in particular to FIG. 8, there is shown a cutting board assembly according to an embodiment of the invention indicated generally as 500 having a primary cutting board 502 and plurality of secondary cutting boards 506a,b. The secondary cutting boards may each include a handle 506a,b to aid in removing the secondary cutting board from the primary cutting board. The secondary cutting boards may be removable from the same end of the primary cutting board, or from either end of the primary cutting board as depicted in FIG. 8. FIG. 9 shows a primary cutting board 601 that is adapted to house a plurality of secondary cutting boards 602a,b by the means of a void space 604. In an aspect the multiple secondary cutting boards are stacked on top of each other within the primary cutting board. The secondary cutting board(s) may be supported in the void space by support members 606a,b. In an embodiment each secondary cutting board may be separated by an optional divider 608a. In such an embodiment, the support members 606a,b provide support to the lowermost secondary cutting board, while all other secondary cutting boards are supported by the optional divider(s) 608a.

The primary and secondary cutting boards can be constructed of materials including stone, marble, treated and untreated woods, hard synthetic plastic materials including acrylics such as Corian®, manufactured by E. I. du Pont de Nemours and Company (DuPont), and metals such as aluminum, pyrolitic carbon and the like. The primary and secondary cutting boards may be constructed of a laminate such as Richlite® 1000, which is manufactured by the Richlite Company. In an embodiment the primary and secondary cutting boards are constructed of the same material. In another embodiment, the primary and secondary cutting boards are constructed from different materials. In an aspect the primary cutting board is constructed from a material selected from the group of marble, treated wood, untreated wood, aluminum and metal.

In an aspect the secondary cutting board is constructed from a material that is resistant to water and can be cleaned by submersion in water or in a dishwasher machine. In an aspect the secondary cutting board is constructed from a material selected from stone, marble, hard synthetic plastic, Corian, aluminum, metal and pyrolitic carbon. In a more specific embodiment the primary cutting board is constructed from treated or untreated wood and the secondary cutting board is constructed from Corian. In another specific embodiment the primary cutting board is constructed from treated or untreated wood and the secondary cutting board is constructed from a laminate. The treated and untreated wood includes (but is not limited to) conventional cutting board constructed such as face grain, edge grain and end grain lamination of hardwood pieces.

Embodiments of the present invention can include where the primary cutting board may be from ½ inch to 6 inches in thickness, 3 inches to 3 feet in width, and 3 inches to 3 feet in length. The thickness of the primary cutting board may range from 1 to 5 inches, or more specifically, 1 to 3 inches. The width of the primary cutting board may range from 6 inches to 2 feet, or more specifically, 9 inches to 1.5 feet. The length of the primary cutting board may range from 6 inches to 2 feet, or more specifically, 9 inches to 1.5 feet.

Embodiments of the present invention can include where the secondary cutting board may be from ⅛ inch to 3 inches in thickness, 2 inches to 2.5 feet in width, and 2 inches to 2.5 feet in length. The thickness of the secondary cutting board may range from ¼ to 2 inches, or more specifically, ½ to 1 inch. The width of the secondary cutting board may range from 5 inches to 1.8 feet, or more specifically, 8 inches to 1.4 feet. The length of the secondary cutting board may range from 5 inches to 1.8 feet, or more specifically, 8 inches to 1.4 feet. In an embodiment, the secondary cutting board is of any size that can be housed completely within the primary cutting board.

The primary and secondary cutting boards may each take a variety of different shapes. In an embodiment the primary and secondary cutting boards each have the same shape. In another embodiment the primary and secondary cutting boards each have different shapes. The cutting boards may have a circular, square, rectangular, octagonal or any other shape.

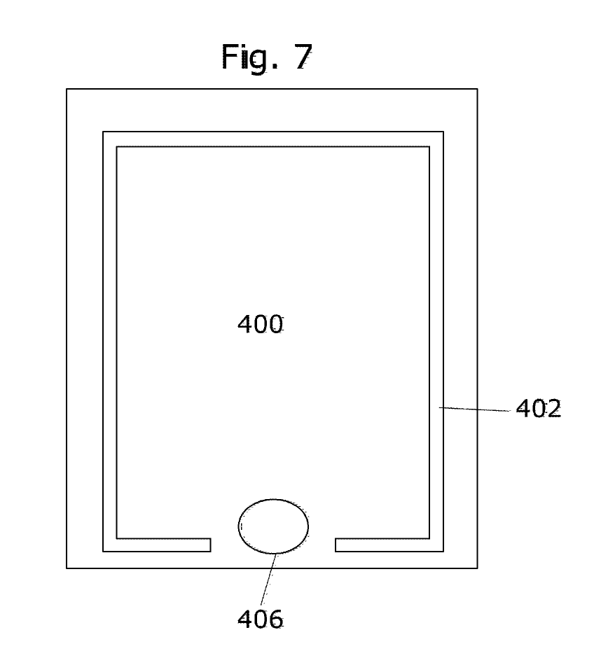

Referring again to the drawings and in particular to FIG. 7, there is shown an embodiment of a secondary cutting board 400 having a juice groove 402 and a handle 406. The juice groove is used for collecting juice and other liquids resulting from cutting vegetables, fruits, or meats on the cutting board.

In an embodiment the cutting board assembly is attached to a knife drawer or knife block. The knife drawer or knife block may contain individualized compartments or recesses designed for each knife. In another embodiment the cutting board assembly contains an integrated knife drawer or block. The integrated knife drawer or knife block may be cut, molded, etc. such that the knife drawer or knife block and the cutting board assembly form one continuous piece.

As used herein, the term “cutting board” includes any surface that may support cutting, dicing, chopping, slicing, etc. such as a chopping block or any other cutting surface.

As used herein, the term “primary cutting board” includes any cutting board that is adapted to house or contain a secondary cutting board.

As used herein, the term “secondary cutting board” includes any cutting surface that may be housed, contained within, or attached to a primary cutting board.

As used herein, the term “void space” includes a space within a primary cutting board that is capable of housing a secondary cutting board.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A cutting board assembly comprising:
a primary cutting board; and
a secondary cutting board;
wherein the secondary cutting board is housed within a void space of the primary cutting board.

2. The cutting board assembly of claim 1, wherein the secondary cutting board is completely removable from the primary cutting board.

3. The cutting board assembly of claim 1, wherein the primary cutting board is constructed from a material selected from the group consisting of marble, treated wood, untreated wood, aluminum and metal.

4. The cutting board assembly of claim 1, wherein the secondary cutting board is constructed from a material selected from the group consisting of stone, marble, hard synthetic plastic, Corian, laminate, aluminum, metal and pyrolitic carbon.

5. The cutting board assembly of claim 1, wherein the primary cutting board comprises treated wood and the secondary cutting board comprises a water-resistant material.

6. The cutting board assembly of claim 1, wherein the void space is open.

7. The cutting board assembly of claim 1, wherein the void space is closed.

8. The cutting board assembly of claim 1, wherein the secondary cutting board comprises a juice groove.

9. The cutting board assembly of claim 1, wherein the void space is of sufficient size to completely house the secondary cutting board.

10. The cutting board assembly of claim 1, further comprising a knife storage apparatus.

11. A cutting board assembly comprising:
a primary cutting board;
a plurality of secondary cutting boards; and
wherein the secondary cutting boards are housed within the primary cutting board.

12. The cutting board assembly of claim 11, wherein the secondary cutting boards are completely removable from the primary cutting board.

13. The cutting board assembly of claim 11, wherein the primary cutting board is constructed from a material selected from the group consisting of marble, treated wood, untreated wood, aluminum and metal.

14. The cutting board assembly of claim 11, wherein the secondary cutting boards are constructed from a material selected from the group consisting of stone, marble, hard synthetic plastic, Corian, laminate, aluminum, metal and pyrolitic carbon.

15. The cutting board assembly of claim 11, wherein the primary cutting board and the plurality of secondary cutting boards are each constructed from a different material.

16. The cutting board assembly of claim 11, wherein the void space is open.

17. The cutting board assembly of claim 11, wherein the void space is closed.

18. The cutting board assembly of claim 11, wherein the void space is of sufficient size to completely house the plurality of secondary cutting boards.

19. The cutting board assembly of claim 1, comprising a divider situated between each secondary cutting board.

20. A cutting board assembly comprising:
a primary cutting board;
a plurality of secondary cutting boards;
wherein the secondary cutting boards are housed within the primary cutting board;
wherein each cutting board is removable on either end of the primary cutting board.
